(19) United States
(12) Patent Application Publication
(10) Pub. No.: US 2026/0181546 A1
(43) Pub. Date: Jun. 25, 2026

(54) RESOURCE SCHEDULING METHOD AND APPARATUS

(71) Applicant: HUAWEI TECHNOLOGIES CO., LTD., Shenzhen (CN)

(72) Inventors: Jun Wang, Shanghai (CN); Chenghui Peng, Shanghai (CN); Fei Wang, Shanghai (CN); Zhe Liu, Shanghai (CN); Huanhuan Huang, Shanghai (CN)

(21) Appl. No.: 19/539,197

(22) Filed: Feb. 13, 2026

Related U.S. Application Data
(63) Continuation of application No. PCT/CN2023/112968, filed on Aug. 14, 2023.

(51) Int. Cl. H04W 52/02

(52) U.S. Cl. CPC H04W 52/0216

(57) ABSTRACT

This application relates to the field of wireless communication technologies, and provides a resource scheduling method and an apparatus, to implement utilization of computational power resources by a terminal device. In the method, a terminal device obtains a computational power resource. The terminal device determines a computational power control parameter of one or more services, and allocates the computational power resource to the one or more services based on the computational power control parameter.

### CROSS-REFERENCE TO RELATED APPLICATIONS

This is a continuation of International Patent Application No. PCT/CN2023/112968, filed on Aug. 14, 2023, the disclosure of which is hereby incorporated by reference in its entirety.

### TECHNICAL FIELD

This application relates to the field of wireless communication technologies, and in particular, to a resource scheduling method and an apparatus.

### BACKGROUND

With emergence of an ultra-large artificial intelligence (AI) model and services with a large computation amount such as an extended reality (XR) service, a bottleneck of single-point computing may gradually emerge on both a network device and a terminal device. Therefore, supporting sharing of computational power in a wireless network is a future trend. With introduction of pan-terminals (for example, vehicle terminals that support self-driving and that have different levels of computational capabilities), capabilities of terminal devices are continuously enhanced, and the terminal can share computational power of the terminal with a network, to assist in network computing. Currently, there is no technical solution for sharing the computational power of the terminal device. In addition, there is no technical solution in the related art about how to allocate computational power to a task after a terminal obtains computational power resources.

### SUMMARY

This application provides a resource scheduling method and an apparatus, to implement sharing and utilization of computational power by a terminal device.

According to a first aspect, a resource scheduling method is provided. The method may be performed by a terminal device, or may be performed by a chip/chip system. In the method, the terminal device obtains a computational power resource. The terminal device determines a computational power control parameter of one or more services, and allocates the computational power resource to the one or more services based on the computational power control parameter. Based on this solution, the terminal device may allocate, based on a computational power control parameter, a computational power resource to a service that has a computing requirement, to implement sharing and utilization of computational power of the terminal device.

In a possible implementation, the terminal device receives configuration information from a network device, where the configuration information includes a parameter used to determine the computational power control parameter. Based on this solution, the terminal device may determine the computational power control parameter based on a configuration of the network device.

In a possible implementation, the configuration information includes a guaranteed time window and a first rate, the computational power control parameter is a product of the first rate and the guaranteed time window, the first rate is an amount of computational power allocated in unit time, and the guaranteed time window is used to determine duration of the computational power control parameter.

Based on this solution, the computational power control parameter may be determined based on the first rate and the guaranteed time window. In other words, the terminal device may allocate a computational power resource based on a rate.

In a possible implementation, the computational power control parameter is a product of a second rate of the one or more services and first duration of the one or more services. The second rate is an amount of computational power allocated in unit time, and the first duration is duration between a moment at which the computational power control parameter is determined and a moment at which the computational power control parameter is determined last time.

Based on this solution, the computational power control parameter may be determined based on the second rate and duration during which a service is not allocated with a computational power resource, so that starvation of a low-rate service can be avoided during computational power resource allocation.

In a possible implementation, when the product of the second rate and the first duration is greater than or equal to the product of the first rate and the guaranteed time window, the computational power control parameter is the product of the first rate and the guaranteed time window. When the product of the second rate and the first duration is less than the product of the first rate and the guaranteed time window, the computational power control parameter is the product of the second rate and the first duration.

Based on this solution, the terminal device may update the computational power control parameter before computational power resource allocation, so that fair computational power allocation can be implemented during computational power resource allocation, to avoid a case in which a high-priority service is always preferentially allocated with a computational power resource and always preempts the computational power resource, and a low-priority service is always waiting and cannot obtain a computational power resource. In this way, starvation of the low-priority service is avoided.

In a possible implementation, the terminal device allocates the computational power resource to the one or more services based on the computational power control parameter and a priority of the one or more services.

In a possible implementation, the terminal device allocates a computational power resource to a service that has a highest priority and whose computational power control parameter is greater than 0 in the one or more services. Based on this solution, the terminal device may allocate the computational power resource to the service based on the priority and the computational power control parameter, to implement fair computational power allocation. This avoids a case in which a high-priority service is always preferentially allocated with a computational power resource and always preempts the computational power resource, and a low-priority service is always waiting and cannot obtain a computational power resource. In this way, starvation of the low-priority service is avoided.

In a possible implementation, the terminal device allocates, when there is a service with an infinite rate in the one or more services, a computational power resource to the service with the infinite rate. Based on this solution, if a rate is infinite, it may be considered that a computational power control parameter is infinite. Therefore, the terminal device may preferentially allocate the computational power resource to the service with the infinite rate, that is, an infinite computational power control parameter.

In a possible implementation, when there is a remaining computational power resource, the remaining computational power resource is discarded. Based on this solution, one computational power resource cannot be shared by different services. When there is a remaining computational power resource, the remaining computational power resource may be discarded.

In a possible implementation, indication information of the remaining computational power resource is sent to the network device, where the indication information of the remaining computational power resource indicates a request for deactivating the remaining computational power resource. Based on this solution, the terminal device may indicate a discarded computational power resource to the network device, so that the network device can reschedule and indicate the discarded computational power resource.

In a possible implementation, when there is a remaining computational power resource, the remaining computational power resource is allocated to a service whose computational power control parameter is greater than 0 in the one or more services. Based on this solution, one computational power resource can be shared by different services. When there is a remaining computational power resource, the remaining computational power resource may be allocated to another service.

In a possible implementation, when there is the remaining computational power resource, the remaining computational power resource is allocated in descending order of priorities of services whose computational power control parameters are greater than 0 in the one or more services. Based on this solution, one computational power resource can be shared by different services. When there is a remaining computational power resource, computational power allocation may be performed based on a priority and/or a computational power control parameter of a service.

In a possible implementation, when there is the remaining computational power resource, and a size of a computational power resource requested by the one or more services is 0, the remaining computational power resource is allocated to a service whose computational power control parameter is less than 0 in the one or more services. Based on this solution, one computational power resource may be shared by different services. When there is a remaining computational power resource, although a computational power control parameter is less than 0, a computational power resource may be allocated to a service when the service has a computational power requirement.

In a possible implementation, the computational power control parameter is updated, where an updated computational power control parameter is determined based on the computational power control parameter and a computational power resource allocated to a corresponding service. Based on this solution, the terminal device may update the computational power control parameter, for a next time of computational power resource allocation.

In a possible implementation, an association relationship between a service and a computational power resource is received. The association relationship indicates that the computational power resource is used to execute the service, or the association relationship indicates that the computational power resource is not available for executing the service. The computational power resource is allocated to the one or more services based on the association relationship and/or the computational power control parameter. Based on this solution, the terminal device may reserve a computational power resource for a specific service.

According to a second aspect, a resource scheduling method is provided. The method may be performed by a terminal device, or may be performed by a chip/chip system. In the method, the terminal device activates or deactivates a first computational power resource, and executes a first service based on the first computational power resource and/or a second computational power resource. The first computational power resource is different from the second computational power resource. In this way, a computational power resource of the terminal device can be enabled or disabled, to reduce energy consumption of the terminal device or reduce a service delay.

In a possible implementation, the first computational power resource is a secondary computational power resource, and the second computational power resource is a primary computational power resource.

In a possible implementation, the terminal device activates the first computational power resource based on a first preset condition. The first preset condition includes one or more of a condition 1 to a condition 3: Condition 1: It is determined, based on a quality of service (QoS) requirement of a service, to activate or deactivate the first computational power resource. For example, the terminal may estimate QoS of the service, and determine whether the QoS requirement of the service can be met, to activate or deactivate the first computational power resource. Condition 2: It is determined, based on load of the second computational power resource, to activate or deactivate the first computational power resource. For example, when the load of the second computational power resource is greater than or is great than or equal to a first preset threshold, the terminal may determine that the first computational power resource needs to be activated. Condition 3: It is determined, based on an association relationship between service information and a computational power resource, that the first computational power resource is used to execute the first service or that the second computational power resource is not available for executing the first service. Based on this solution, the terminal device may determine, based on a preset condition, whether the first computational power resource needs to be activated.

In a possible implementation, the terminal device receives the first preset condition from a network device. Based on this solution, the terminal device may determine, based on a condition configured by the network device, whether to activate the first computational power resource.

In a possible implementation, the terminal device sends first information to the network device, where the first information includes one or more conditions that are met in the first preset condition. Based on this solution, the terminal device may send, to the network device, a condition that the terminal device meets, to help the network device determine whether the first computational power resource needs to be activated.

In a possible implementation, the terminal device deactivates the first computational power resource based on a second preset condition. The second preset condition includes one or more of a condition 4 to a condition 7:

Condition 4: Load of the second computational power resource is compared with a second preset threshold, to determine that the first computational power resource needs to be deactivated. For example, when the load of the second computational power resource is less than or is less than or equal to the second preset threshold, the terminal may determine that the first computational power resource needs to be deactivated. For another example, when duration during which the load of the second computational power resource is less than or is less than or equal to the second preset threshold reaches first preset duration, the terminal may determine that the first computational power resource needs to be deactivated.

Condition 5: Load of the second computational power resource is compared with a third preset threshold, and load of the first computational power resource is compared with a fourth preset threshold, to determine that the first computational power resource needs to be deactivated. For example, when the load of the second computational power resource is less than or is less than or equal to the third preset threshold, and load of the first computational power resource is less than or is less than or equal to the fourth preset threshold, the terminal may determine that the first computational power resource needs to be deactivated. For another example, when duration during which the load of the second computational power resource is less than or is less than or equal to the third preset threshold, and load of the first computational power resource is less than or is less than or equal to the fourth preset threshold reaches second preset duration, the terminal may determine that the first computational power resource needs to be deactivated.

Condition 6: Start duration of the first computational power resource reaches second duration. The start duration of the first computational power resource may be understood as duration of activating, enabling, or starting the first computational power resource.

Condition 7: It is determined, based on an association relationship between service information and a computational power resource, that the first computational power resource needs to be deactivated.

Based on this solution, the terminal device may determine, based on a preset condition, whether the first computational power resource needs to be deactivated.

In a possible implementation, the terminal device receives the second preset condition from the network device. Based on this solution, the terminal device may determine, based on a condition configured by the network device, whether the first computational power resource needs to be deactivated.

In a possible implementation, the terminal device sends second information to the network device, where the second information includes one or more conditions that are met in the second preset condition. Based on this solution, the terminal device may send, to the network device, a condition that the terminal device meets, to help the network device determine whether the first computational power resource needs to be deactivated.

In a possible implementation, the terminal device sends third information and/or fourth information to the network device. The third information includes an identifier of the first computational power resource, and the third information indicates to activate the first computational power resource. The fourth information includes an identifier of the first computational power resource, and the fourth information indicates to deactivate the first computational power resource.

Based on this solution, the terminal device may notify the network device after activating or deactivating the first computational power resource.

In a possible implementation, the terminal device determines that the second computational power resource cannot meet quality of service requirement of the first service, and sends the third information to the network device, where the third information indicates to activate the first computational power resource. Based on this solution, the terminal device may determine, based on a quality of service requirement of a service, whether to activate the first computational power resource.

In a possible implementation, the terminal device receives indication information from the network device, where the indication information indicates to activate or deactivate the first computational power resource. The terminal device activates or deactivates the first computational power resource based on the indication information. Based on this solution, the terminal device may activate or deactivate the first computational power resource based on the indication information of the network device.

In a possible implementation, the indication information is carried in one or more of the following: radio resource control (RRC), a media access control (MAC) control element (CE), and downlink control information (DCI).

According to a third aspect, a resource scheduling method is provided. The method may be performed by a first apparatus. The first apparatus may be a terminal device or a chip/chip system. In the method, the first apparatus sends request information to a second apparatus, where the request information is used to request a computational power resource of the second apparatus, and the request information includes one or more of a computation amount, quality of service, a service identifier, and a computational power resource identifier. The first apparatus receives response information from the second apparatus, where the response information indicates that requesting the computational power resource succeeds or requesting the computational power resource fails.

Optionally, the first apparatus may be a modem, and the second apparatus may be an application processing unit (APU). Based on this solution, the modem may schedule a computational power resource of the APU to execute a computing requirement of a service.

According to a fourth aspect, a resource scheduling method is provided. The method may be performed by a network device, or may be performed by a chip/chip system. In the method, the network device determines a parameter used by a terminal device to determine a computational power control parameter. The network device sends configuration information to the terminal device, where the configuration information includes the parameter. The computational power control parameter is used by the terminal device to allocate a computational power resource.

In a possible implementation, the configuration information includes a guaranteed time window and a rate, the computational power control parameter is a product of the rate and the guaranteed time window, the rate is an amount of computational power allocated in unit time, and the guaranteed time window is used to determine duration of the computational power control parameter.

In a possible implementation, the network device sends, to the terminal device, an association relationship between a service and a computational power resource. The association relationship indicates that the computational power resource is used to execute the service, or the association relationship indicates that the computational power resource is not available for executing the service.

According to a fifth aspect, a resource scheduling method is provided. The method may be performed by a network device, or may be performed by a chip/chip system. In the method, the network device sends a first preset condition and/or a second preset condition to a terminal device. The first preset condition is used by the terminal device to determine whether to activate a first computational power resource, and the second preset condition is used by the terminal device to determine whether to deactivate the first computational power resource.

The first preset condition includes one or more of a condition 1 to a condition 3: Condition 1: It is determined, based on a quality of service (QoS) requirement of a service, to activate or deactivate the first computational power resource. For example, the terminal may estimate QoS of the service, and determine whether the QoS requirement of the service can be met, to activate or deactivate the first computational power resource. Condition 2: It is determined, based on load of a second computational power resource, to activate or deactivate the first computational power resource. For example, when the load of the second computational power resource is greater than or is great than or equal to a first preset threshold, the terminal may determine that the first computational power resource needs to be activated. Condition 3: It is determined, based on an association relationship between service information and a computational power resource, that the first computational power resource is used to execute a first service or that the second computational power resource is not available for executing a first service. Based on this solution, the terminal device may determine, based on a preset condition, whether the first computational power resource needs to be activated.

The second preset condition includes one or more of a condition 4 to a condition 7:

Condition 4: Load of a second computational power resource is compared with a second preset threshold, to determine that the first computational power resource needs to be deactivated. For example, when the load of the second computational power resource is less than or is less than or equal to the second preset threshold, the terminal may determine that the first computational power resource needs to be deactivated. For another example, when duration during which the load of the second computational power resource is less than or is less than or equal to the second preset threshold reaches first preset duration, the terminal may determine that the first computational power resource needs to be deactivated.

Condition 5: Load of a second computational power resource is compared with a third preset threshold, and load of the first computational power resource is compared with a fourth preset threshold, to determine that the first computational power resource needs to be deactivated. For example, when the load of the second computational power resource is less than or is less than or equal to the third preset threshold, and load of the first computational power resource is less than or is less than or equal to the fourth preset threshold, the terminal may determine that the first computational power resource needs to be deactivated. For another example, when duration during which the load of the second computational power resource is less than or is less than or equal to the third preset threshold, and load of the first computational power resource is less than or is less than or equal to the fourth preset threshold reaches second preset duration, the terminal may determine that the first computational power resource needs to be deactivated.

Condition 6: Start duration of the first computational power resource reaches second duration. The start duration of the first computational power resource may be understood as duration of activating, enabling, or starting the first computational power resource.

Condition 7: It is determined, based on an association relationship between service information and a computational power resource, that the first computational power resource needs to be deactivated.

In a possible implementation, the network device receives third information and/or fourth information from the terminal device. The third information includes an identifier of the first computational power resource, and the third information indicates to activate the first computational power resource. The fourth information includes an identifier of the first computational power resource, and the fourth information indicates to deactivate the first computational power resource.

In a possible implementation, the network device sends indication information to the terminal device, where the indication information indicates to activate or deactivate the first computational power resource.

In a possible implementation, the indication information is carried in one or more of the following: RRC, a MAC-CE, and DCI.

According to a sixth aspect, a resource scheduling method is provided. The method may be performed by a second apparatus. The second apparatus may be a terminal device or a chip/chip system. In the method, the second apparatus receives request information from a first apparatus, where the request information is used to request a computational power resource of the second apparatus, and the request information includes one or more of a computation amount, quality of service, a service identifier, and a computational power resource identifier. The second apparatus sends response information to the first apparatus, where the response information indicates that requesting the computational power resource succeeds or requesting the computational power resource fails.

According to a seventh aspect, a communication apparatus is provided. The communication apparatus includes a processing unit.

The processing unit is configured to obtain a computational power resource. The processing unit is further configured to: determine a computational power control parameter of one or more services, and allocate the computational power resource to the one or more services based on the computational power control parameter.

In a possible implementation, the communication apparatus further includes a transceiver unit, configured to receive configuration information from a network device, where the configuration information includes a parameter used to determine the computational power control parameter.

In a possible implementation, the configuration information includes a guaranteed time window and a rate, the computational power control parameter is a product of the rate and the guaranteed time window, the rate is an amount of computational power allocated in unit time, and the guaranteed time window is used to determine duration of the computational power control parameter.

In a possible implementation, the computational power control parameter is a product of a rate of the one or more services and first duration of the one or more services. The first duration is duration between a moment at which the computational power control parameter is determined and a moment at which the computational power control parameter is determined last time.

In a possible implementation, when the product of the rate and the first duration is greater than or equal to the product of the rate and the guaranteed time window, the computational power control parameter is the product of the rate and the guaranteed time window. When the product of the rate and the first duration is less than the product of the rate and the guaranteed time window, the computational power control parameter is the product of the rate and the first duration. The guaranteed time window is used to determine the duration of the computational power control parameter.

In a possible implementation, the processing unit is further configured to allocate the computational power resource to the one or more services based on the computational power control parameter and a priority of the one or more services.

In a possible implementation, the processing unit is further configured to allocate a computational power resource to a service that has a highest priority and whose computational power control parameter is greater than 0 in the one or more services.

In a possible implementation, the processing unit is further configured to allocate, when there is a service with an infinite rate in the one or more services, a computational power resource to the service with the infinite rate.

In a possible implementation, the processing unit is further configured to discard, when there is a remaining computational power resource, the remaining computational power resource.

In a possible implementation, the transceiver unit is further configured to send indication information of the remaining computational power resource to the network device, where the indication information of the remaining computational power resource indicates a request for deactivating the remaining computational power resource.

In a possible implementation, the processing unit is further configured to allocate, when there is a remaining computational power resource, the remaining computational power resource to a service whose computational power control parameter is greater than 0 in the one or more services.

In a possible implementation, the processing unit is further configured to allocate, when there is the remaining computational power resource, the remaining computational power resource in descending order of priorities of services whose computational power control parameters are greater than 0 in the one or more services.

In a possible implementation, the processing unit is further configured to: when there is the remaining computational power resource, and a size of a computational power resource requested by the one or more services is 0, allocate the remaining computational power resource to a service whose computational power control parameter is less than 0 in the one or more services.

In a possible implementation, the processing unit is further configured to update the computational power control parameter, where an updated computational power control parameter is determined based on the computational power control parameter and a computational power resource allocated to a corresponding service.

In a possible implementation, the transceiver unit is further configured to receive an association relationship between a service and a computational power resource. The association relationship indicates that the computational power resource is used to execute the service, or the association relationship indicates that the computational power resource is not available for executing the service. The processing unit is further configured to allocate the computational power resource to the one or more services based on the association relationship and/or the computational power control parameter.

According to an eighth aspect, a communication apparatus is provided. The communication apparatus includes a processing unit.

The processing unit is configured to: activate or deactivate a first computational power resource, and execute a first service based on the first computational power resource and/or a second computational power resource. The first computational power resource is different from the second computational power resource.

In a possible implementation, the first computational power resource is a secondary computational power resource, and the second computational power resource is a primary computational power resource.

In a possible implementation, the processing unit is further configured to activate the first computational power resource based on a first preset condition. The first preset condition includes one or more of a condition 1 to a condition 3: Condition 1: It is determined, based on a quality of service (QoS) requirement of a service, to activate or deactivate the first computational power resource. For example, the terminal may estimate QoS of the service, and determine whether the QoS requirement of the service can be met, to activate or deactivate the first computational power resource. Condition 2: It is determined, based on load of the second computational power resource, to activate or deactivate the first computational power resource. For example, when the load of the second computational power resource is greater than or is great than or equal to a first preset threshold, the terminal may determine that the first computational power resource needs to be activated. Condition 3: It is determined, based on an association relationship between service information and a computational power resource, that the first computational power resource is used to execute the first service or that the second computational power resource is not available for executing the first service. Based on this solution, the terminal device may determine, based on a preset condition, whether the first computational power resource needs to be activated.

In a possible implementation, the communication apparatus further includes a transceiver unit, configured to receive the first preset condition from a network device.

In a possible implementation, the transceiver unit is further configured to send first information to the network device, where the first information includes one or more conditions that are met in the first preset condition.

In a possible implementation, the processing unit is further configured to deactivate the first computational power resource based on a second preset condition. The second preset condition includes one or more of a condition 4 to a condition 7:

Condition 4: Load of the second computational power resource is compared with a second preset threshold, to determine that the first computational power resource needs to be deactivated. For example, when the load of the second computational power resource is less than or is less than or equal to the second preset threshold, the terminal may determine that the first computational power resource needs to be deactivated. For another example, when duration during which the load of the second computational power resource is less than or is less than or equal to the second preset threshold reaches first preset duration, the terminal may determine that the first computational power resource needs to be deactivated.

Condition 5: Load of the second computational power resource is compared with a third preset threshold, and load of the first computational power resource is compared with a fourth preset threshold, to determine that the first computational power resource needs to be deactivated. For example, when the load of the second computational power resource is less than or is less than or equal to the third preset threshold, and load of the first computational power resource is less than or is less than or equal to the fourth preset threshold, the terminal may determine that the first computational power resource needs to be deactivated. For another example, when duration during which the load of the second computational power resource is less than or is less than or equal to the third preset threshold, and load of the first computational power resource is less than or is less than or equal to the fourth preset threshold reaches second preset duration, the terminal may determine that the first computational power resource needs to be deactivated.

Condition 6: Start duration of the first computational power resource reaches second duration. The start duration of the first computational power resource may be understood as duration of activating, enabling, or starting the first computational power resource.

Condition 7: It is determined, based on an association relationship between service information and a computational power resource, that the first computational power resource needs to be deactivated.

In a possible implementation, the transceiver unit is further configured to receive the second preset condition from the network device. Based on this solution, the terminal device may determine, based on a condition configured by the network device, whether the first computational power resource needs to be deactivated.

In a possible implementation, the transceiver unit is further configured to send second information to the network device, where the second information includes one or more conditions that are met in the second preset condition.

In a possible implementation, the transceiver unit is further configured to send third information and/or fourth information to the network device. The third information includes an identifier of the first computational power resource, and the third information indicates to activate the first computational power resource. The fourth information includes an identifier of the first computational power resource, and the fourth information indicates to deactivate the first computational power resource.

In a possible implementation, the processing unit is further configured to: determine that the second computational power resource cannot meet quality of service of the first service, and send the third information to the network device, where the third information indicates to activate the first computational power resource.

In a possible implementation, the transceiver unit is further configured to receive indication information from the network device, where the indication information indicates to activate or deactivate the first computational power resource. The processing unit is further configured to activate or deactivate the first computational power resource based on the indication information.

In a possible implementation, the indication information is carried in one or more of the following: RRC, a MAC-CE, and DCI.

According to a ninth aspect, a communication apparatus is provided. The communication apparatus includes a processing unit and a transceiver unit.

The processing unit is configured to generate request information. The transceiver unit is configured to send the request information to a second apparatus, where the request information is used to request a computational power resource of the second apparatus, and the request information includes one or more of a computation amount, quality of service, a service identifier, and a computational power resource identifier. The transceiver unit is further configured to receive response information from the second apparatus, where the response information indicates that requesting the computational power resource succeeds or requesting the computational power resource fails.

According to a tenth aspect, a communication apparatus is provided. The communication apparatus includes a processing unit and a transceiver unit.

The processing unit is configured to determine a parameter used by a terminal device to determine a computational power control parameter. The transceiver unit is configured to send configuration information to the terminal device, where the configuration information includes the parameter. The computational power control parameter is used by the terminal device to allocate a computational power resource.

In a possible implementation, the configuration information includes a guaranteed time window and a rate, the computational power control parameter is a product of the rate and the guaranteed time window, the rate is an amount of computational power allocated in unit time, and the guaranteed time window is used to determine duration of the computational power control parameter.

In a possible implementation, the transceiver unit is further configured to send, to the terminal device, an association relationship between a service and a computational power resource. The association relationship indicates that the computational power resource is used to execute the service, or the association relationship indicates that the computational power resource is not available for executing the service.

According to an eleventh aspect, a communication apparatus is provided. The communication apparatus includes a processing unit and a transceiver unit.

The processing unit is configured to determine a first preset condition and/or a second preset condition. The transceiver unit is configured to send the first preset condition and/or the second preset condition to a terminal device. The first preset condition is used by the terminal device to determine whether to activate a first computational power resource, and the second preset condition is used by the terminal device to determine whether to deactivate the first computational power resource.

The first preset condition includes one or more of a condition 1 to a condition 3: Condition 1: It is determined, based on a quality of service (QoS) requirement of a service, to activate or deactivate the first computational power resource. For example, the terminal may estimate QoS of the service, and determine whether the QoS requirement of the service can be met, to activate or deactivate the first computational power resource. Condition 2: It is determined, based on load of a second computational power resource, to activate or deactivate the first computational power resource. For example, when the load of the second computational power resource is greater than or is great than or equal to a first preset threshold, the terminal may determine that the first computational power resource needs to be activated. Condition 3: It is determined, based on an association relationship between service information and a computational power resource, that the first computational power resource is used to execute a first service or that the second computational power resource is not available for executing a first service. Based on this solution, the terminal device may determine, based on a preset condition, whether the first computational power resource needs to be activated.

The second preset condition includes one or more of a condition 4 to a condition 7:

Condition 4: Load of a second computational power resource is compared with a second preset threshold, to determine that the first computational power resource needs to be deactivated. For example, when the load of the second computational power resource is less than or is less than or equal to the second preset threshold, the terminal may determine that the first computational power resource needs to be deactivated. For another example, when duration during which the load of the second computational power resource is less than or is less than or equal to the second preset threshold reaches first preset duration, the terminal may determine that the first computational power resource needs to be deactivated.

Condition 5: Load of a second computational power resource is compared with a third preset threshold, and the load of first computational power resource is compared with a fourth preset threshold, to determine that the first computational power resource needs to be deactivated. For example, when the load of the second computational power resource is less than or is less than or equal to the third preset threshold, and load of the first computational power resource is less than or is less than or equal to the fourth preset threshold, the terminal may determine that the first computational power resource needs to be deactivated. For another example, when duration during which the load of the second computational power resource is less than or is less than or equal to the third preset threshold, and load of the first computational power resource is less than or is less than or equal to the fourth preset threshold reaches second preset duration, the terminal may determine that the first computational power resource needs to be deactivated.

Condition 6: Start duration of the first computational power resource reaches second duration. The start duration of the first computational power resource may be understood as duration of activating, enabling, or starting the first computational power resource.

Condition 7: It is determined, based on an association relationship between service information and a computational power resource, that the first computational power resource needs to be deactivated.

In a possible implementation, the transceiver unit is further configured to receive third information and/or fourth information from the terminal device. The third information includes an identifier of the first computational power resource, and the third information indicates to activate the first computational power resource. The fourth information includes an identifier of the first computational power resource, and the fourth information indicates to deactivate the first computational power resource.

In a possible implementation, the transceiver unit is further configured to send indication information to the terminal device, where the indication information indicates to activate or deactivate the first computational power resource.

In a possible implementation, the indication information is carried in one or more of the following: RRC, a MAC-CE, and DCI.

According to a twelfth aspect, a communication apparatus is provided. The communication apparatus includes a processing unit and a transceiver unit.

The transceiver unit is configured to receive request information from a first apparatus, where the request information is used to request a computational power resource of a second apparatus, and the request information includes one or more of a computation amount, quality of service, a service identifier, and a computational power resource identifier. The processing unit is configured to generate response information. The transceiver unit is further configured to send the response information to the first apparatus, where the response information indicates that requesting the computational power resource succeeds or requesting the computational power resource fails.

According to a thirteenth aspect, an embodiment of this application provides a communication apparatus. The communication apparatus may be the communication apparatus according to any one of the seventh aspect to the twelfth aspect in the foregoing embodiments, or a chip disposed in the communication apparatus according to any one of the seventh aspect to the twelfth aspect. The communication apparatus includes a communication interface and a processor, and optionally, further includes a memory. The memory is configured to store a computer program, instructions, or data. The processor is coupled to the memory and the communication interface. When the processor reads the computer program, the instructions, or the data, the communication apparatus performs the method performed by the terminal device or the network device in the method embodiments in any one of the first aspect to the sixth aspect.

It should be understood that the communication interface may be implemented by using an antenna, a feeder, a codec, and the like in the communication apparatus. Alternatively, if the communication apparatus is a chip disposed in a communication device, the communication interface may be an input/output interface of the chip, for example, an input/output pin. The communication apparatus may further include a transceiver, used by the communication apparatus to communicate with another device.

According to a fourteenth aspect, this application provides a communication apparatus, including a logic circuit and an input/output interface. The logic circuit is configured to perform the method performed by the network device or the terminal device in any one of the possible implementations in the first aspect to the sixth aspect. The input/output interface is configured to communicate with another communication apparatus.

According to a fifteenth aspect, an embodiment of this application provides a chip system. The chip system includes a processor, and may further include a memory, configured to implement the method performed by the network device or the terminal device in any one of the first aspect to the sixth aspect. In a possible implementation, the chip system further includes a memory, configured to store program instructions and/or data. The chip system may include a chip, or may include a chip and another discrete component.

According to a sixteenth aspect, an embodiment of this application provides a communication system. The communication system includes the communication apparatus according to any one of the seventh aspect or the tenth aspect. Alternatively, the communication system includes the communication apparatus in either the eighth aspect or the eleventh aspect. Alternatively, the communication system includes the communication apparatus in either the ninth aspect or the twelfth aspect.

According to a seventeenth aspect, this application provides a computer-readable storage medium. The computer-readable storage medium stores a computer program or instructions. When the computer program or the instructions are run, the methods performed by the network device or the terminal device in the foregoing aspects are implemented.

According to an eighteenth aspect, a computer program product is provided. The computer program product includes computer program code or instructions. When the computer program code or the instructions are run, the methods performed by the network device or the terminal device in the foregoing aspects are performed.

According to a nineteenth aspect, a communication apparatus is provided. The communication apparatus includes units or modules configured to perform the methods in the foregoing aspects.

For beneficial effects of the fourth aspect to the nineteenth aspect and the implementations thereof, refer to the descriptions of the beneficial effects of the methods according to the first aspect to the third aspect and the implementations thereof.

### BRIEF DESCRIPTION OF DRAWINGS

FIG. 1 is a diagram of a communication system according to an embodiment of this application;

FIG. 2 is an example flowchart of a resource scheduling method according to an embodiment of this application;

FIG. 3 is a diagram of a token bucket according to an embodiment of this application;

FIG. 4 is a diagram of a trustlist according to an embodiment of this application;

FIG. 5 is an example flowchart of another resource scheduling method according to an embodiment of this application;

FIG. 6 is an example flowchart of another resource scheduling method according to an embodiment of this application;

FIG. 7 is a diagram of an API according to an embodiment of this application;

FIG. 8 is a diagram of a communication apparatus according to an embodiment of this application;

FIG. 9 is a diagram of another communication apparatus according to an embodiment of this application;

FIG. 10 is a diagram of another communication apparatus according to an embodiment of this application; and

FIG. 11 is a diagram of another communication apparatus according to an embodiment of this application.

### DESCRIPTION OF EMBODIMENTS

For ease of understanding of the technical solutions provided in embodiments of this application, the following explains and describes technical terms used in this application.
(1) Computational power refers to a capability of processing information, and also refers to a capability of executing a specific computing requirement.
(2) A computational power resource, like a central processing unit (CPU) or a graphics processing unit (GPU), is a resource used to execute a computing requirement. Optionally, from a time domain perspective, a time slice is a minimum computational power resource.
(3) A service may also be referred to as a task, an application (APP), or the like.
(4) Activating a specific computational power resource may also be referred to as enabling the specific computational power resource or starting the specific computational power resource, and means that the specific computational power resource is used to execute a computing requirement. Similarly, deactivating a specific computational power resource may also be referred to as disabling the specific computational power resource, and means that the specific computational power resource is not used to execute a computing requirement.

The following describes in detail embodiments of this application with reference to the accompanying drawings of the specification.

The technical solutions in embodiments of this application may be applied to a new radio (NR) system, a long-term evolution (LTE) system, an LTE frequency division duplex (FDD) system, an LTE time division duplex (TDD) system, a worldwide interoperability for microwave access (WiMAX) communication system, and the like. This is not limited herein.

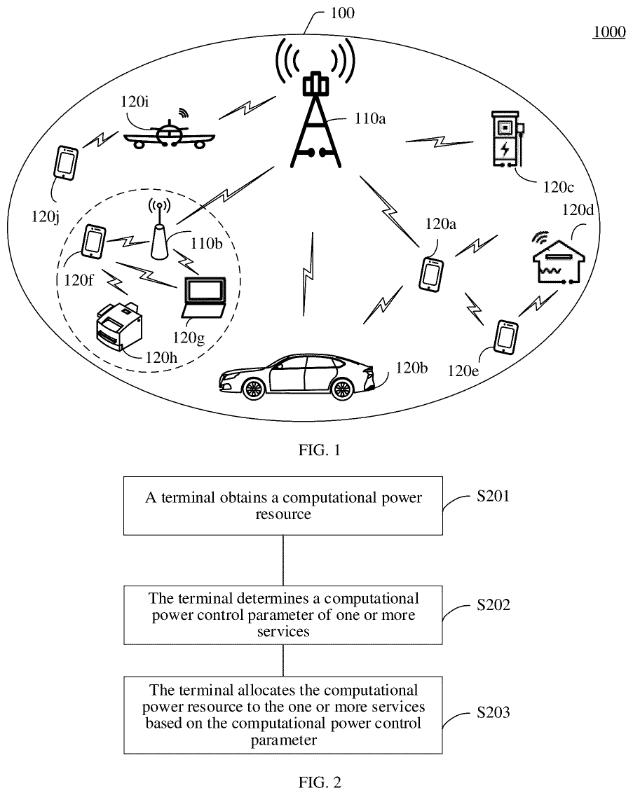

FIG. 1 is a diagram of an architecture of a communication system 1000 to which an embodiment of this application is applied. As shown in FIG. 1, the communication system includes a radio access network 100. The radio access network 100 may include at least one network device (for example, 110a and/or 110b in FIG. 1), and may further include at least one terminal apparatus (for example, at least one of 120a to 120j in FIG. 1). The terminal apparatus is connected to an access network device in a wireless manner, and the access network device is connected to a core network device in a wireless or wired manner. Terminal apparatuses may be connected to each other in a wired or wireless manner, and network devices may be connected to each other in a wired or wireless manner. FIG. 1 is only a diagram. The communication system may further include other network devices, for example, may further include a wireless relay device and a wireless backhaul device. This is not shown in FIG. 1.

The network device is a network side device having a wireless transceiver function. The network device may be an apparatus that is in a radio access network (RAN) and that provides a wireless communication function for a terminal device, and is referred to as a RAN device. For example, the network device may be a base station, an evolved NodeB (eNB), a transmission reception point (TRP), a next-generation NodeB (gNB) in a 5th generation (5G) mobile communication system, a next generation base station in a 6th generation (6G) mobile communication system, a base station in a future mobile communication system, an access node in a Wi-Fi system, or the like; or may be a module or a unit that completes a part of functions of a base station, for example, may be a central unit (CU) or a distributed unit (DU). The CU herein completes functions of a radio resource control protocol and a packet data convergence protocol (PDCP) of a base station, and may further complete a function of a service data adaptation protocol (SDAP). The DU completes functions of a radio link control layer and a medium access control (MAC) layer of a base station, and may further complete a part or all of functions of a physical layer. For detailed descriptions of the foregoing protocol layers, refer to technical specifications related to the 3rd generation partnership project (3GPP). The network device may be a macro base station (for example, 110a in FIG. 1), may be a micro base station or an indoor base station (for example, 110b in FIG. 1), or may be a relay node, a donor node, or the like. A specific technology and a specific device form that are used by the network device are not limited in embodiments of this application. In embodiments of this application, an example in which the base station serves as the network device is used for description.

In another possible scenario, a plurality of RAN nodes collaborate to assist a terminal in implementing radio access, and different RAN nodes separately implement a part of functions of the base station. For example, the RAN node may be a CU, a DU, a CU-control plane (CP), a CU-user plane (UP), or a radio unit (RU). The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH).

In different systems, the CU (or the CU-CP and the CU-UP), the DU, or the RU may also have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP and the CU-UP), the DU, and the RU in this application may be implemented by using a software module, a hardware module, or a combination of a software module and a hardware module.

The terminal device is a user side device having a wireless transceiver function. The terminal device may also be referred to as user equipment (UE), a mobile station, a mobile terminal, or the like. The terminal apparatus may be widely used in various scenarios such as device-to-device (D2D), vehicle-to-everything (V2X) communication, machine-type communication (MTC), an internet of things (IoT), virtual reality, augmented reality, industrial control, self-driving, telemedicine, a smart grid, smart furniture, a smart office, smart wearables, smart transportation, and a smart city. The terminal apparatus may be a mobile phone, a tablet computer, a computer having a wireless transceiver function, a wearable device, a vehicle, an uncrewed aerial vehicle, a helicopter, an airplane, a ship, a robot, a mechanical arm, a smart home device, or the like. A specific technology and a specific apparatus form that are used by the terminal apparatus are not limited in embodiments of this application. In embodiments of this application, an example in which a terminal serves as the terminal device is used for description.

The network device and the terminal device may be at fixed locations, or may be movable. The network device and the terminal device may be deployed on land, including indoor devices, outdoor devices, handheld devices, or vehicle-mounted devices; may be deployed on water; or may be deployed on an airplane, a balloon, and an artificial satellite in the air. Application scenarios of the network device and the terminal device are not limited in embodiments of this application.

Roles of the network device and the terminal device may be relative. For example, a helicopter or an uncrewed aerial vehicle 120i in FIG. 1 may be configured as a mobile network device. For the terminal device 120j that accesses the radio access network 100 via 120i, the terminal device 120i is a network device. However, for the network device 110a, 120i is a terminal device, to be specific, 110a and 120i communicate with each other by using a wireless air interface protocol. Certainly, 110a and 120i may alternatively communicate with each other by using an interface protocol between network devices. In this case, for 110a, 120i is also a network device. Therefore, the network device and the terminal device may be collectively referred to as communication apparatuses. 110a and 110b in FIG. 1 may be referred to as communication apparatuses having a function of a network device, and 120a to 120j in FIG. 1 may be referred to as communication apparatuses having a function of a terminal device.

In embodiments of this application, the function of the network device may alternatively be performed by a module (for example, a chip) in the network device, or may be performed by a control subsystem including the function of the network device. The control subsystem including the function of the network device may be a control center in the foregoing application scenarios such as the smart grid, the industrial control, the smart transportation, and the smart city. The function of the terminal device may alternatively be performed by a module (for example, a chip or a modem) in the terminal device, or may be performed by an apparatus including a function of the terminal device.

With emergence of an ultra-large artificial intelligence (AI) model and services with a large computation amount such as an extended reality (XR) service, a bottleneck of single-point computing may gradually emerge on both the network device and the terminal device. Therefore, supporting sharing of computational power in a wireless network is a future trend. With introduction of pan-terminals (for example, vehicle terminals that support self-driving and that have different levels of computational capabilities), capabilities of terminal devices are continuously enhanced, and the terminal can share and use computational power of the terminal with a network, to assist in network computing. Currently, there is no technical solution for sharing the computational power of the terminal device. In cloud computing, functions such as sharing of the computational power and scheduling of the computational power that correspond to distributed computing are supported, but are generally in a cloud network and implemented and deployed based on a fixed network. For example, a plurality of compute nodes are centrally managed and scheduled by a unified node that is used for centralized management and control. However, the cloud network supports simple sharing and scheduling of the computational power, and the fixed network-based method cannot be reused in the wireless network. In addition, there is no technical solution in the related art about how to allocate computational power to a task after a terminal obtains computational power resources.

In view of this, an embodiment of this application provides a resource scheduling method. In the method, a terminal device may obtain a computational power resource, and determine a computational power control parameter of one or more services. The terminal device may allocate the obtained computational power resource to the one or more services based on the computational power control parameter. Based on this solution, the terminal device may allocate, based on a computational power control parameter, a computational power resource to a service that has a computing requirement, to implement sharing of computational power of the terminal device.

FIG. 2 is an example flowchart of a resource scheduling method according to an embodiment of this application. The following operations may be included. The embodiment shown in FIG. 2 may be performed by the terminal device and the network device shown in FIG. 1. In the following, an example in which the terminal device is a terminal and the network device is a base station is used for description.

Optionally, the embodiment shown in FIG. 2 may include the following operation S201.

S201: The terminal obtains a computational power resource.

In a possible case, the terminal may obtain a preconfigured computational power resource.

In another possible case, the terminal may request a computational power resource from the base station, and the base station schedules or allocates the computational power resource to the terminal. For example, the terminal may receive computational power resource indication information from the base station. The computational power resource indication information may indicate a computational power resource, and the terminal may obtain the computational power resource indicated by the computational power resource indication information.

S202: The terminal determines a computational power control parameter of one or more services.

For example, the terminal may obtain a priority (task priority) of the one or more services as the computational power control parameter. For another example, the terminal may obtain a token bucket of the one or more services as the computational power control parameter. For another example, the terminal may combine a priority and a token bucket that are of the service as the computational power control parameter. Optionally, the computational power control parameter may represent a computational power allocation priority of the one or more services.

In a possible implementation, the terminal may determine the computational power control parameter based on configuration information of the base station. The base station may send the configuration information to the terminal, where the configuration information may include a parameter used to determine the computational power control parameter. For example, the configuration information may include a priority of the one or more services, and the terminal may use the priority as the computational power control parameter of the service. For another example, the configuration information may include a parameter used to determine a token bucket of the service. For example, the configuration information may include a guaranteed time window and a rate. The terminal may use a product of the guaranteed time window and the rate as the token bucket of the service, that is, the computational power control parameter of the service. The rate is an amount of computational power allocated in unit time, for example, may be a CPU/GPU time slice, a CPU/GPU proportion, or a computation amount. The guaranteed time window, namely, bucket size duration (BSD) is used to determine duration of the computational power control parameter.

It should be noted that the rate in this specification may also be referred to as a prioritized computing rate (PCR), or may have another name. This is not specifically limited in this application.

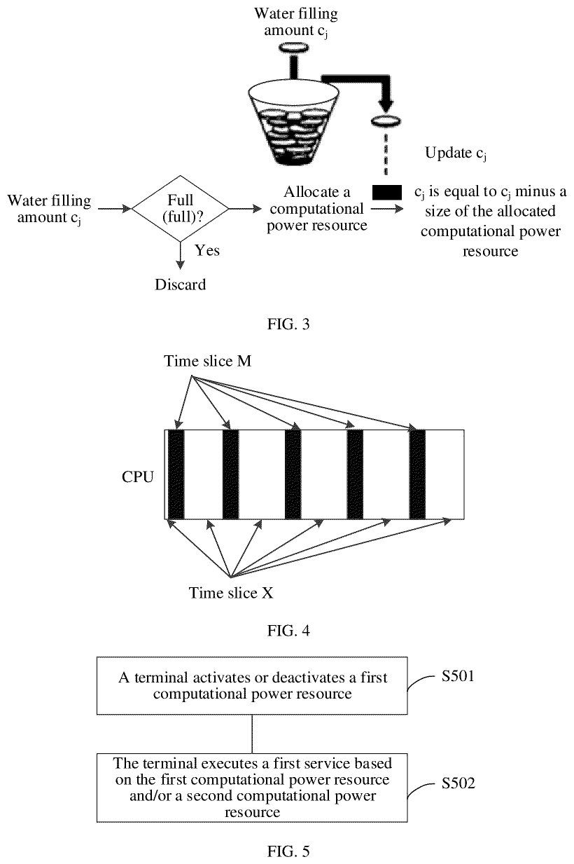

In another possible implementation, the terminal may independently determine and maintain the computational power control parameter, for example, the token bucket, of the service. Refer to FIG. 3. A terminal may maintain a token bucket of each service. The terminal may set a total water storage amount cⱼ in the token bucket to cⱼ=cⱼ₋₁+PCR (rate)*T (first duration). The first duration may be duration between a moment at which cⱼ is determined and a moment at which cⱼ₋₁ is determined, and the rate may be indicated by the base station or preconfigured.

It may be understood that the subscript j may be understood as a j^{th} time of computational power resource allocation. For example, cⱼ may be understood as a total water storage amount in the token bucket during a j^{th} time of computational power resource allocation, and cⱼ₋₁ may be understood as a total water storage amount in the token bucket during a (j-1)^{th} time of computational power resource allocation. j may be an integer greater than or equal to 0. In this specification, an example in which an initial value of j is 0 is used for description. It may be understood that the initial value of j may alternatively be a preset value, for example, 1 or 2. Optionally, cⱼ may have an initial value, and the initial value may be preset. That is, c₀ may be preset, for example, may be set to 0, or may be set to a value related to a priority. In other words, c may be set to the value related to the priority. For example, a higher priority indicates a higher initial value. It should be noted that in this specification, cⱼ may be greater than 0, equal to 0, or less than 0.

Optionally, the terminal may determine the computational power control parameter, for example, the token bucket, of the service, with reference to the foregoing two possible implementations. For example, the terminal may independently determine the total water storage amount cⱼ in the token bucket of the service, for example, cⱼ=cⱼ₋₁+PCR (rate)*T (first duration). Before performing computational power allocation, for example, before performing S203, the terminal may update the total water storage amount cⱼ in the token bucket based on the configuration information of the base station. For example, the terminal may compare cⱼ with PCR*BSD, to update the token bucket. For example, when cⱼ is greater than or is great than or equal to PCR*BSD, the terminal may use PCR*BSD as a total water storage amount cⱼ of the service. When cⱼ is less than or is less than or equal to PCR*BSD, cⱼ is still used as the total water storage amount cⱼ of the service. In this case, the terminal may fill token buckets of all services with water, and allocate a computational power resource to a service based on a total water storage amount in a token bucket. Therefore, during computational power resource allocation, a rate of the service can be considered, and starvation of a low-rate service can be avoided.

S203: The terminal allocates the computational power resource to the one or more services based on the computational power control parameter.

For example, the terminal may allocate the computational power resource to the one or more services in descending order of computational power control parameters. For example, when the computational power control parameter is a priority, the terminal may allocate the computational power resource to the one or more services in descending order of priorities. Based on this solution, the terminal may preferentially allocate a computational power resource to a high-priority service.

For another example, when the computational power control parameter is a token bucket, the terminal may allocate the computational power resource to the one or more services in descending order of total water storage amounts in token buckets. Optionally, when the computational power control parameter includes a priority and a token bucket, the terminal may allocate the computational power resource to the one or more services with reference to the token bucket and the priority. For example, the terminal may preferentially allocate, in descending order of priorities, a computational power resource to a service whose total water storage amount in a token bucket is greater than 0. For another example, the terminal may allocate the computational power resource to the one or more services in descending order of total water storage amounts in token buckets. When the total water storage amounts are the same, the terminal may preferentially allocate a computational power resource to a high-priority service. Optionally, the terminal may preferentially allocate a computational power resource to a service with an infinite rate (infinity). Based on the manner of determining the token bucket described in S202, if a rate is infinite, it may be considered that cⱼ is infinite. Therefore, the terminal may preferentially allocate the computational power resource to the service with the infinite rate, that is, with cⱼ that is infinite.

Based on this solution, the terminal may allocate the computational power resource to the service based on the total water storage amount cⱼ in the token bucket, to implement fair computational power allocation. This avoids a case in which a high-priority service is always preferentially allocated with a computational power resource and always preempts the computational power resource, and a low-priority service is always waiting and cannot obtain a computational power resource. In this way, starvation of the low-priority service is avoided.

In a possible implementation, different services may be allowed or not allowed to reuse a specific computational power resource. For example, the terminal allocates a computational power resource A, for example, a time slice n (where n is an integer greater than or equal to 1), to a service 1. When a computing requirement of the service 1 is met and there is still a remaining computational power resource in the computational power resource A, that is, another computing requirement can be further executed, the remaining computational power resource may be allocated to another service, for example, a service 2 or a service 3, or the remaining computational power resource cannot be allocated to another service, and needs to be discarded.

Optionally, when the remaining computational power resource cannot be allocated to another service, the terminal may send indication information of the remaining computational power resource, for example, an identifier or an index of the remaining computational power resource, to the base station, to indicate to deactivate the remaining computational power resource.

In a possible case, if a specific computational power resource allows to be reused by different services, the terminal may allocate a remaining resource of the computational power resource to another service in the manner described in S203, until there is no remaining computational power resource or there is no service that has a computing requirement. For example, the terminal may allocate, in descending order of priorities, the remaining computational power resource to a service that has a computing requirement and whose cⱼ is greater than 0.

Optionally, after the computational power resource is allocated to the service that has the computing requirement and whose cⱼ is greater than 0, if there is still a remaining computational power resource, the terminal may allocate the remaining computational power resource to a service that has a computing requirement, until there is no remaining computational power resource or there is no service that has a computing requirement. It may be understood that, cⱼ of the foregoing service that has the computing requirement may be less than 0. If there is a remaining computational power resource after the computational power resource is allocated to the service that has the computing requirement and whose cⱼ is greater than 0, the remaining computational power resource may be allocated to the service even if cⱼ<0.

In another possible case, if a specific computational power resource does not allow to be reused by different services, the terminal may discard a remaining resource of the computational power resource. It may be understood that discarding a computational power resource may be understood as not using the computational power resource to execute any compute task. Optionally, the terminal may send an identifier, for example, a time slice, of a discarded computational power resource to the base station. For example, in time slices n1 to n3, the time slices n1 and n2 are allocated to a service 1, where n1≤n2<n3, and the time slices n2 and n3 are remaining computational power resources. Because different services are not allowed to reuse one computational power resource, the terminal needs to discard the time slices n2 and n3, and send identifiers of the time slices n2 and n3 to the base station.

In another possible implementation, the terminal may reserve a computational power resource for a specific service. For example, the terminal may obtain a trustlist or a blocklist. The trustlist may include an association relationship between service information and a computational power resource, and the trustlist may indicate that the computational power resource may be used to execute a computing requirement of a service corresponding to the service information having the association relationship. The blocklist may also include an association relationship between service information and a computational power resource, and the blocklist may indicate that the computational power is not available for executing a computing requirement of a service corresponding to the service information having the association relationship. Optionally, the blocklist or the trustlist may be indicated by the base station or preconfigured.

It should be noted that the service information may include a service identifier and/or a logical channel. The logical channel may be in one-to-one correspondence with a service, or a plurality of services may correspond to one logical channel. This is not specifically limited in this application.

The terminal may reserve a computational power resource for the specific service once or a plurality of times. The computational power resource may be periodically or aperiodically reserved a plurality of times. This is not specifically limited in this application. Optionally, information about the computational power resource reserved by the terminal for the specific service may be indicated in the trustlist or the blocklist.

Refer to FIG. 4. It is assumed that time slices M marked by black rectangles in a CPU in a trustlist are associated with a service 1. In this case, the terminal may determine whether the service 1 has a computing requirement. If the service 1 has the computing requirement, the terminal may allocate the time slices M to the service 1. If the service 1 does not have the computing requirement, the terminal may discard the time slices M. It may be understood that, because the time slices M are associated with the service 1, even if there is a remaining resource in the time slices M, the remaining resource cannot be allocated to another service. If another service, for example, a service 2 to a service N, has a computing requirement, the terminal may allocate, to the service 2 to the service N, time slices X that are not marked by the black rectangles in FIG. 4. It may be understood that, for a manner in which the terminal allocates computational power resources, for example, time slices, to the service 2 to the service N, refer to S203 for implementation. Details are not described herein again.

Before performing S203, the terminal may sort services in descending order of priorities, and allocate computational power resources based on values of cⱼ of the services. For details, refer to the foregoing related descriptions. Details are not described herein again.

Optionally, the terminal may filter the computational power resources based on the foregoing trustlist or blocklist, to be specific, determine a specific computational power resource that can be allocated to one or more services, and allocate the computational power resource based on the value of cⱼ of the services. For example, if the terminal determines, based on the trustlist or the blocklist, that a computational power resource X can be used only for a service A, the terminal may allocate the computational power resource X to the service A, and allocate, according to the descriptions in S203, another computational power resource, for example, a computational power resource M, to another service that has a computing requirement. For another example, if the terminal determines, based on the trustlist or the blocklist, that a computational power resource X can be used for a service A and a service B, the terminal allocates the computational power resource X to the service A and/or the service B according to the descriptions in S203, and allocates, according to the descriptions in S203, another computational power resource, for example, a computational power resource M, to another service that has a computing requirement. It may be understood that, for a resource reusing manner, refer to the foregoing related descriptions. Details are not described herein again.

In an example, refer to FIG. 3. After performing S203, the terminal may update the computational power control parameter of the service, for example, update the token bucket of the service. The total water storage amount cⱼ in the token bucket is equal to cⱼ minus a size of an allocated computational power resource. Optionally, the size of the allocated computational power resource may be represented by duration occupied by a time slice, for example, may be represented in a unit of ms or s. For example, for a service 1, the terminal allocates time slices 1, 2, and 3 to the service 1, and the time slices 1, 2, and 3 occupy 10s in total. In this case, the terminal may update a token bucket of the service 1, to make a total water storage amount cⱼ in the token bucket of the service 1 equal to cⱼ−10.

According to the foregoing solution, the terminal may allocate a computational power resource to each service based on a process of water filling and consumption in a token bucket, so that a problem of computational power allocation in a multi-service scenario can be resolved, and starvation of a low-priority or a low-rate service can be avoided.

In embodiments of this application, a method for computational power resource allocation by the terminal in the multi-service scenario is described based on the foregoing embodiments. Currently, a terminal may have a plurality of CPUs/GPUs, that is, the terminal may be multi-core. How to control the terminal to enable or disable the plurality of CPUs, to reduce energy consumption of the terminal or reduce a service delay is a technical problem to be resolved.

In view of this, embodiments of this application further provide another resource scheduling method. In the method, a terminal may independently determine to activate or deactivate a first computational power resource, or activate or deactivate a first computational power resource based on an indication of a base station. In this way, a CPU of the terminal can be enabled or disabled, to achieve a beneficial effect of reducing energy consumption of the terminal or reducing a service delay.

FIG. 5 is an example flowchart of a resource scheduling method according to an embodiment of this application. The following operations may be included. It may be understood that the embodiment shown in FIG. 5 may be performed by the terminal device and the network device shown in FIG. 1. In the following, an example in which the terminal device is a terminal and the network device is a base station is used for description.

S501: The terminal activates or deactivates a first computational power resource.

For example, the terminal may independently determine, based on a preconfigured condition, to activate or deactivate the first computational power resource. For another example, the terminal may activate or deactivate the first computational power resource based on an indication of the base station.

Optionally, the embodiment shown in FIG. 5 may further include the following operation S502.

S502: The terminal executes a first service based on the first computational power resource and/or a second computational power resource.

For example, the terminal may execute a compute task of the first service based on the first computational power resource and/or the second computational power resource. The first computational power resource and the second computational power resource are different computational power resources. For example, the first computational power resource may be a secondary computational power resource, for example, a secondary CPU/secondary GPU, and the second computational power resource may be a primary computational power resource, for example, a primary CPU/primary GPU.

The following describes, based on Manner 1 and Manner 2, manners in which the terminal activates or deactivates the first computational power resource in S501.

Manner 1: The terminal determines to activate or deactivate the first computational power resource.

In this manner, the terminal may independently determine to activate or deactivate the first computational power resource. For example, the terminal may activate the first computational power resource based on a first preset condition. For example, the terminal may activate the first computational power resource when the first preset condition is met. The first preset condition may be preconfigured, may be predefined in a protocol, or may be indicated by the base station. Optionally, the first preset condition may include one or more of the following:

Condition 1: It is determined, based on a quality of service (QoS) requirement of a service, to activate or deactivate the first computational power resource.

For example, the terminal may estimate QoS of the service, and determine whether the QoS requirement of the service can be met, to activate or deactivate the first computational power resource. For example, if the terminal executes the first service based on the second computational power resource, and the terminal determines that a QoS requirement of the first service cannot be met, the terminal may activate the first computational power resource. For another example, if the terminal has activated the first computational power resource and the second computational power resource, and the terminal determines that a QoS requirement of the first service can be met based only on the second computational power resource, the terminal may deactivate the first computational power resource to reduce energy consumption.

Condition 2: It is determined, based on load of the second computational power resource, to activate or deactivate the first computational power resource.

For example, the terminal may compare the load of the second computational power resource with a first preset threshold, to determine that the first computational power resource needs to be activated. For example, when the load of the second computational power resource is greater than or is great than or equal to the first preset threshold, the terminal may determine that the first computational power resource needs to be activated.

For another example, if the load of the second computational power resource is large and is close to a maximum value, the terminal may activate the first computational power resource. For another example, if the terminal has activated the first computational power resource and the second computational power resource, but the load of the second computational power resource is low, the terminal may deactivate the first computational power resource to reduce energy consumption.

Condition 3: It is determined, based on an association relationship between service information and a computational power resource, that the first computational power resource is used to execute the first service or that the second computational power resource is not available for executing the first service.

For example, the terminal may obtain a trustlist. The trustlist may include the association relationship between the service information and the computational power resource. For descriptions of the trustlist, refer to the embodiment shown in FIG. 3. Details are not described herein again. When the terminal determines, based on the trustlist, that the first computational power resource can be used to execute the first service, and the first service has a computing requirement, the terminal may determine that the first computational power resource needs to be activated.

For another example, the terminal may obtain a blocklist. The blocklist may include the association relationship between the service information and the computational power resource. For descriptions of the blocklist, refer to the embodiment shown in FIG. 3. Details are not described herein again. When the terminal determines, based on the blocklist, that the second computational power resource is not available for executing the first service, and the first service has a computing requirement, the terminal may determine that the first computational power resource needs to be activated.

When at least one of the condition 1 to the condition 3 is met, the terminal may activate the first computational power resource. In an example, the terminal may notify the base station of information about the activated first computational power resource. For example, the terminal may send an identifier of the first computational power resource to the base station. Optionally, the terminal may send the information about the first computational power resource to the base station by using signaling or an information element used to activate a computational power resource. In other words, the terminal may send the information about the first computational power resource to the base station by using signaling or an information element dedicated to activating a computational power resource. Alternatively, the terminal may send the information about the first computational power resource and a corresponding action, for example, activation, to the base station. In other words, the terminal may notify, by including the information about the first computational power resource and the corresponding action in general-purpose signaling or a an information element, the base station that the first computational power resource is activated.

In another possible case, the terminal may deactivate the first computational power resource based on a second preset condition. For example, the terminal may deactivate the first computational power resource when the second preset condition is met. The second preset condition may be preconfigured, may be predefined in a protocol, or may be indicated by the base station. Optionally, the second preset condition may include one or more of the following:

Condition 4: Load of the second computational power resource is compared with a second preset threshold, to determine that the first computational power resource needs to be deactivated.

For example, when the load of the second computational power resource is less than or is less than or equal to the second preset threshold, the terminal may determine that the first computational power resource needs to be deactivated. For another example, when duration during which the load of the second computational power resource is less than or is less than or equal to the second preset threshold reaches first preset duration, the terminal may determine that the first computational power resource needs to be deactivated.

Condition 5: Load of the second computational power resource is compared with a third preset threshold, and load of the first computational power resource is compared with a fourth preset threshold, to determine that the first computational power resource needs to be deactivated.

For example, when the load of the second computational power resource is less than or is less than or equal to the third preset threshold, and load of the first computational power resource is less than or is less than or equal to the fourth preset threshold, the terminal may determine that the first computational power resource needs to be deactivated. For another example, when duration during which the load of the second computational power resource is less than or is less than or equal to the third preset threshold, and load of the first computational power resource is less than or is less than or equal to the fourth preset threshold reaches second preset duration, the terminal may determine that the first computational power resource needs to be deactivated.

It should be noted that the first preset threshold, the second preset threshold, the third preset threshold, and the fourth preset threshold may be the same or may be different, and the first preset duration and the second preset duration may be the same or may be different. This is not specifically limited in this application.

Condition 6: Start duration of the first computational power resource reaches second duration.

The start duration of the first computational power resource may be understood as duration of activating, enabling, or starting the first computational power resource. For example, the terminal may start timing at a moment of activating the first computational power resource. When timing duration reaches the second duration, the terminal may consider that the condition 6 is met. For another example, the terminal may start a timer at a moment of activating the first computational power resource. When the timer expires, the terminal may consider that the condition 6 is met.

Condition 7: It is determined, based on an association relationship between service information and a computational power resource, that the first computational power resource needs to be deactivated.

For example, the terminal may obtain a trustlist. The trustlist may include the association relationship between the service information and the computational power resource. For descriptions of the trustlist, refer to the embodiment shown in FIG. 3. Details are not described herein again. When the terminal determines, based on the trustlist, that the first computational power resource is used to execute a second service, and the second service has no computing requirement, the terminal may determine that the first computational power resource needs to be deactivated.

For another example, the terminal may obtain a blocklist. The blocklist may include the association relationship between the service information and the computational power resource. For descriptions of the blocklist, refer to the embodiment shown in FIG. 3. Details are not described herein again. When the terminal determines, based on the blocklist, that the first computational power resource is not available for executing the first service, the terminal may determine that the first computational power resource needs to be activated.

When at least one of the condition 4 to the condition 7 is met, the terminal may deactivate the first computational power resource. In an example, the terminal may notify the base station of information about the deactivated first computational power resource. For example, the terminal may send an identifier of the first computational power resource to the base station. Optionally, the terminal may send the information about the first computational power resource to the base station by using signaling or an information element used to deactivate a computational power resource. Alternatively, the terminal may send the information about the first computational power resource and a corresponding action, for example, deactivation, to the base station.

According to the foregoing solution, the terminal may independently determine or determine based on a condition to activate or deactivate the first computational power resource, so that energy consumption of the terminal can be reduced and a service delay can be reduced.

Manner 2: The terminal activates or deactivates the first computational power resource based on an indication of the base station.

For example, the terminal may receive signaling information from the base station, and the signaling information may indicate to activate or deactivate the first computational power resource. The terminal may activate or deactivate the first computational power resource based on the indication of the signaling information.

The signaling information may be a single piece of signaling, for example, one of RRC, a MAC-CE, or DCI. Alternatively, the signaling information may be a signaling combination. For example, the base station may indicate, by using a combination of the RRC and the MAC-CE or a combination of the RRC and the DCI, to activate or deactivate the first computational power resource. For example, the base station may send a configuration to the terminal by using RRC, and allocate an identifier/index to each configuration. For example, the base station sends the configuration to the terminal by using the RRC, where activating a CPU 1 corresponds to an index 1, activating a CPU 2 corresponds to an index 2, deactivating/disabling the CPU 1 corresponds to an index 3, and deactivating/disabling the CPU 2 corresponds to an index 4. If the base station expects the terminal to activate the CPU 1, the base station may send a MAC-CE or DCI to the terminal, where the MAC-CE or the DCI may carry the index 1, so that the terminal may determine to activate the CPU 1.

Optionally, information about a computational power resource carried in the RRC in the single signaling or the signaling combination may be a computational power resource identifier, for example, a GPU ID/CPU ID, or a computational power resource identifier list (or group), for example, a CPU ID list/GPU ID list. For example, the base station indicates an activated or deactivated computational power resource to the terminal by using one of the RRC, the MAC CE, or the DCI. One of the RRC, the MAC CE, or the DCI may carry the CPU ID/GPU ID or the CPU ID list/GPU ID list. In this way, the terminal may activate or deactivate a CPU/GPU indicated by the CPU ID/GPU ID or the CPU ID list/GPU ID list. For example, the base station sends a configuration to the terminal by using RRC, and each configuration may carry a CPU ID/GPU ID, or a CPU ID list/GPU ID list, to indicate a CPU/GPU for which each configuration is specific.

Optionally, the RRC in the single piece of signaling or the signaling combination may indicate the activated or deactivated computational power resource by using a bitmap. For example, UE has eight CPUs/GPUs in total, and it is assumed that numbers of the CPUs/GPUs are set to 0 to 7, corresponding to eight bits. A value of a specific bit being 0 may represent that a corresponding CPU/GPU is deactivated. A value of a specific bit being 1 may represent that a corresponding CPU/GPU is activated. For example, 00001000 may represent that the CPU/GPU with the number 4 is activated, and other CPUs/GPUs are deactivated. On the contrary, a value of a specific bit being 1 may represent that a corresponding CPU/GPU is deactivated. A value of a specific bit being 0 may represent that a corresponding CPU/GPU is activated. For example, 11110111 may represent that the CPU/GPU with the number 4 is activated, and other CPUs/GPUs are deactivated.

In a possible case, when the terminal meets any one of the condition 1 to the condition 7, the terminal may send the met condition to the base station, so that the base station may indicate, based on the condition met by the terminal, the terminal to activate or deactivate a specific computational power resource. For example, when the terminal meets the condition 1, for example, when the load of the second computational power resource is greater than or is great than or equal to the preset threshold, the terminal may send indication information to the base station, to indicate that the terminal meets the condition 1. For example, the terminal may send an index corresponding to the condition 1 to the base station. In this way, the base station may indicate the terminal to activate the first computational power resource.

In another possible case, the terminal may report an event to the base station, so that the base station may indicate, based on the event, the terminal to activate or deactivate a specific computational power resource. For example, the base station may configure, for the terminal, a condition for triggering event reporting, for example, one or more of the condition 1 to the condition 6. When the terminal meets the condition for triggering event reporting, the terminal may report the event to the base station. For example, when the terminal meets the condition 1, for example, when the load of the second computational power resource is greater than or is great than or equal to the preset threshold, the terminal may report the event to the base station, to indicate that the load of the second computational power resource of the terminal is greater than or is great than or equal to the preset threshold. For example, the terminal may send an index of the event to the base station. In this way, the base station may indicate the terminal to activate the first computational power resource.

Optionally, the terminal may send indication information to the base station, to indicate or advise the base station to activate or deactivate a specific computational power resource. For example, when the terminal meets one or more of the condition 1 to the condition 7, the terminal may send the indication information to the base station, to indicate to activate or deactivate a specific computational power resource. For example, when the condition 2 is met, for example, when the terminal determines that the first computational power resource is used to execute the first service, the terminal may send, to the base station, indication information for activating the first computational power resource. For example, the terminal may send an identifier of the first computational power resource and a corresponding action, for example, activation. For another example, the terminal estimates whether the QoS requirement of the service can be met, to send indication information to the base station. For example, if the terminal executes the first service based on the second computational power resource, and the terminal determines that the QoS requirement of the first service cannot be met, the terminal sends, to the base station, the indication information for activating the first computational power resource.

According to the foregoing solution, the terminal may activate or deactivate a computational power resource based on an indication of the base station, so that energy consumption of the terminal can be reduced or a service delay can be reduced.

It should be noted that, the embodiment shown in FIG. 5 may be implemented as an independent embodiment, or a person skilled in the art may combine the steps in the embodiments shown in FIG. 5 and FIG. 2 into a complete embodiment for implementation. For example, according to the embodiment shown in FIG. 5, the terminal may activate the first computational power resource. The terminal may allocate the first computational power resource to the service by using the embodiment shown in FIG. 2, for example, allocate an activated CPU/GPU time slice. This is not specifically limited in this application.

This specification describes, according to the foregoing embodiments, a method for activating or deactivating a specific CPU/GPU by a terminal when the terminal has a plurality of CPUs/GPUs. Currently, a computational power resource that can be shared in a wireless network may include a computational power resource, for example, the CPU/GPU, integrated by a modem. However, the modem cannot use a general-purpose computational power resource, for example, an application processing unit (APU), of the terminal. In view of this, embodiments of this application further provide another resource scheduling method, used by a modem to request a general-purpose computational power resource of a terminal to execute a computing requirement of a service.

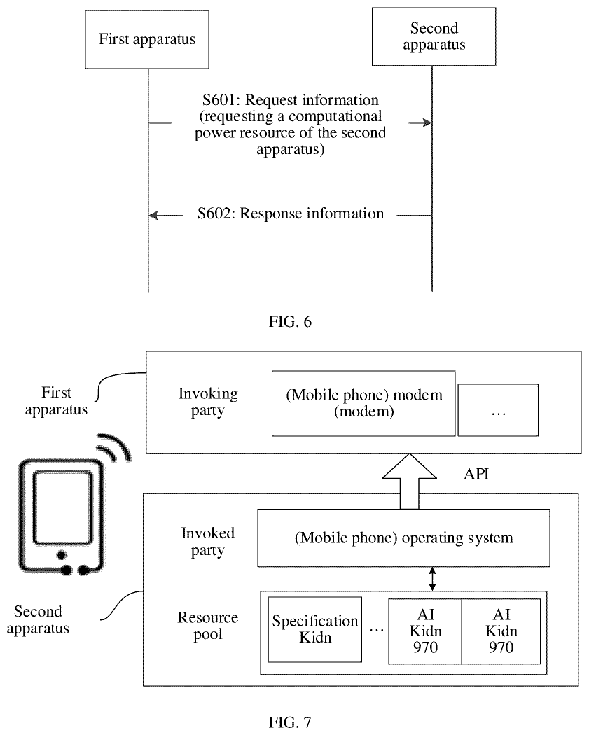

FIG. 6 shows a resource scheduling method according to an embodiment of this application. The following operations may be included.

S601: A first apparatus sends request information to a second apparatus.

Correspondingly, the second apparatus receives the request information from the first apparatus.

The request information may be used to request a computational power resource of the second apparatus. The request information may include one or more of a required computation amount, quality of service, service information, and a computational power resource identifier. Optionally, the first apparatus and the second apparatus may be apparatuses used in different devices. For example, the first apparatus may be an apparatus used in a first device, for example, a chip or a circuit module, or the first apparatus may be the first device. The second apparatus may be an apparatus used in a second device, for example, a chip or a circuit module, or the second apparatus may be the second device.

Optionally, the first apparatus and the second apparatus are different apparatuses used in a same device. For example, the first apparatus may be a modem in a terminal device, and the second apparatus may be an APU in the terminal device.

In a possible implementation, refer to FIG. 7. An embodiment of this application provides an application programming interface (API) between the first apparatus and the second apparatus. In S601, the first apparatus may send the request information to the second apparatus through the API. Three different APIs are provided in this specification. Different APIs need different parameters, which are described below.

API 1: Computation amount: When the first apparatus sends the request information to the second apparatus through the API 1, the request information needs to carry a computation amount of a service, for example, a maximum value (top) of the computation amount or a percentage of the computation amount in a computational power resource of the second apparatus. Based on the API 1, the first apparatus may request, from the second apparatus, a computational power resource that meets a computation amount requirement of the service.

Optionally, the API 1 further needs one or more of the QoS of the service and the computational power resource identifier. The QoS may include a computing delay requirement or a priority, and the computational power resource identifier may include a CPU ID/GPU ID or a location of a CPU/GPU time slice. When the first apparatus sends the request information to the second apparatus through the API 1, the request information needs to carry one or both of the QoS of the service and the computational power resource identifier, and the computation amount of the service. Based on the API 1, the first apparatus may request, from the second apparatus, a computational power resource that is applicable to meeting a QoS requirement of the service and/or matching the computational power resource identifier, to improve efficiency.

API 2: Computational power resource identifier, for example, a location of a CPU/GPU time slice: Optionally, the location of the CPU/GPU time slice may be periodic. When the first apparatus sends the request information to the second apparatus through the API 2, the request information needs to carry the computational power resource identifier. Optionally, the request information may further carry periodicity indication information. Based on the API 2, the first apparatus may request a specific computational power resource from the second apparatus, to execute a corresponding service, especially a periodic service.

API 3: Service information and computational power resource identifier: The service information may include a service identifier or a logical channel, and the computational power resource identifier may include a CPU ID/GPU ID or a location of a CPU/GPU time slice. When the first apparatus sends the request information to the second apparatus through the API 3, the request information needs to carry the service information and the computational power resource identifier. Based on the API 3, the first apparatus may request, from the second apparatus, a computational power resource that is applicable to executing a specific service, to improve efficiency.

S602: The second apparatus sends response information to the first apparatus.

Correspondingly, the second apparatus receives the response information from the first apparatus.

The response information may indicate that requesting the computational power resource succeeds or requesting the computational power resource fails. Optionally, when the response information indicates that requesting the computational power resource succeeds, the first apparatus may use the requested computational power resource to execute the service.

It should be understood that the computational power resource identifier in this embodiment of this application is an example of a manner indicating a computational power resource. Alternatively, the computational power resource may be indicated in another manner or by using other indication information. This is not specifically limited in this application.

It should be noted that the embodiment shown in FIG. 6 may be implemented as an independent embodiment, or a person skilled in the art may combine some steps in embodiments shown in FIG. 2, FIG. 5, and FIG. 6 into an embodiment for implementation. For example, when requesting the computational power resource succeeds in the embodiment shown in FIG. 6, the service may be allocated with the computational power resource in the manner of the embodiment shown in FIG. 2. For another example, when the first computational power resource is activated according to the embodiment shown in FIG. 5, the computing requirement of the service still cannot be met, and the embodiment shown in FIG. 6 may be used to request the general-purpose computational power resource.

The following describes, with reference to the accompanying drawings, a communication apparatus for implementing the foregoing method in embodiments of this application. Therefore, all the foregoing content may be used in the following embodiments. Repeated content is not described in detail again.

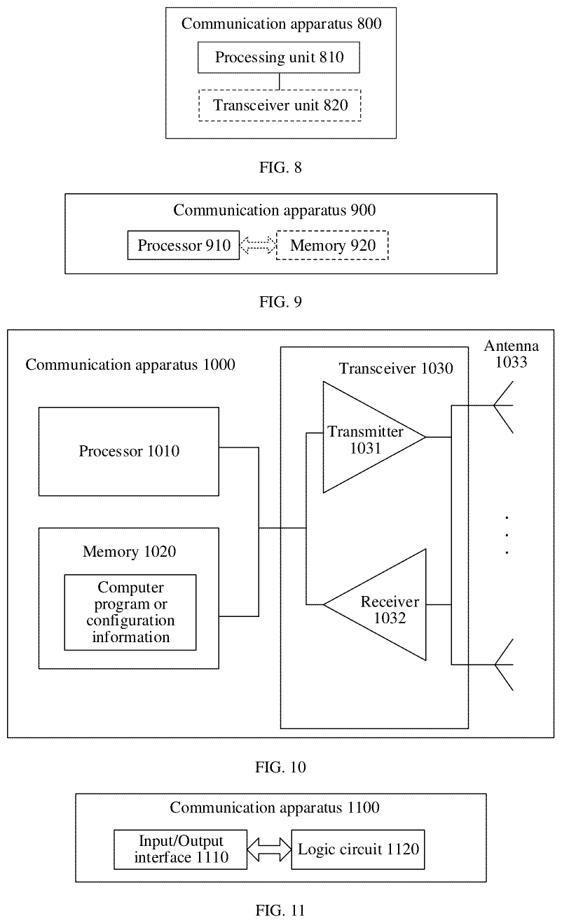

FIG. 8 is a block diagram of a communication apparatus 800 according to an embodiment of this application. The communication apparatus 800 may correspondingly implement functions or steps implemented by the terminal device or the network device in the foregoing method embodiments. The communication apparatus may include a processing unit 810. Optionally, the communication apparatus may further include a transceiver unit 820 and/or a storage unit. The transceiver unit 820 may be configured to perform all receiving or sending operations performed by the terminal device or the network device. The storage unit may be configured to store instructions (code or a program) and/or data. The processing unit 810 may be coupled to the storage unit. For example, the processing unit 810 may read the instructions (the code or the program) and/or the data in the storage unit, to implement a corresponding method. The foregoing units may be independently disposed, or may be partially or completely integrated.

In some possible implementations, the communication apparatus 800 can correspondingly implement behavior and functions of the terminal device in the foregoing method embodiments. For example, the communication apparatus 800 may be the terminal device, or may be a component (for example, a chip or a circuit) used in the terminal device. The processing unit 810 is configured to perform all operations performed by the terminal device in the embodiment shown in FIG. 2 or FIG. 5 except the sending and receiving operations. For example, the processing unit 810 performs S201, S202, and S203 in the embodiment shown in FIG. 2, and/or another process used to support the technology described in this specification.

For example, the processing unit 810 is configured to obtain a computational power resource. The processing unit 810 is further configured to: determine a computational power control parameter of one or more services, and allocate the computational power resource to the one or more services based on the computational power control parameter.

For another example, the processing unit 810 is configured to: activate or deactivate a first computational power resource, and execute a first service based on the first computational power resource and/or a second computational power resource. The first computational power resource is different from the second computational power resource.

In some possible implementations, the communication apparatus 800 can correspondingly implement behavior and functions of the network device in the foregoing method embodiments. For example, the communication apparatus 800 may be the network device, or may be a component (for example, a chip or a circuit) used in the network device. The transceiver unit 820 may be configured to perform all receiving or sending operations performed by the network device. The processing unit 810 is configured to perform all operations performed by the network device except the sending and receiving operations.

For example, the processing unit 810 is configured to determine a parameter used by a terminal device to determine the computational power control parameter. The transceiver unit 820 is configured to send configuration information to the terminal device, where the configuration information includes the parameter. The computational power control parameter is used by the terminal device to allocate a computational power resource.

For another example, the processing unit 810 is configured to determine a first preset condition and/or a second preset condition. The transceiver unit 820 is configured to send the first preset condition and/or the second preset condition to the terminal device. The first preset condition is used by the terminal device to determine whether to activate a first computational power resource, and the second preset condition is used by the terminal device to determine whether to deactivate the first computational power resource. For the first preset condition and the second preset condition, refer to the related descriptions in the method embodiments.

For operations performed by the processing unit 810 and the transceiver unit 820, refer to the related descriptions in the foregoing method embodiments.

It should be understood that the processing unit 810 in this embodiment of this application may be implemented by a processor or a processor-related circuit component, and the transceiver unit 820 may be implemented by a transceiver, a transceiver-related circuit component, or a communication interface.

Based on a same concept, as shown in FIG. 9, an embodiment of this application provides a communication apparatus 900. The communication apparatus 900 includes a processor 910. Optionally, the communication apparatus 900 may further include a memory 920, configured to store instructions executed by the processor 910, or store input data required by the processor 910 to run instructions, or store data generated after the processor 910 runs instructions. The processor 910 may implement, by using the instructions stored in the memory 920, the method shown in the foregoing method embodiments.

Based on a same concept, as shown in FIG. 10, an embodiment of this application provides a communication apparatus 1000. The communication apparatus 1000 may be a chip or a chip system. Optionally, in this embodiment of this application, the chip system may include a chip, or may include a chip and another discrete device.

The communication apparatus 1000 may include at least one processor 1010. The processor 1010 is coupled to a memory. Optionally, the memory may be located inside or outside the apparatus. For example, the communication apparatus 1000 may further include at least one memory 1020. The memory 1020 stores a necessary computer program, configuration information, a computer program or instructions, and/or data for implementing any one of the foregoing embodiments. The processor 1010 may execute the computer program stored in the memory 1020, to complete the method in any one of the foregoing embodiments.

The coupling in this embodiment of this application may be an indirect coupling or a communication connection between apparatuses, units, or modules in an electrical form, a mechanical form, or another form, and is used for information exchange between the apparatuses, the units, or the modules. The processor 1010 and the memory 1020 may operate cooperatively. In embodiments of this application, a specific connection medium between a transceiver 1030, the processor 1010, and the memory 1020 is not limited.

The communication apparatus 1000 may further include the transceiver 1030, and the communication apparatus 1000 may perform information exchange with another device by using the transceiver 1030. The transceiver 1030 may be a circuit, a bus, a transceiver, or any other apparatus that can be configured to exchange information, or is referred to as a signal transceiver unit. As shown in FIG. 10, the transceiver 1030 includes a transmitter 1031, a receiver 1032, and an antenna 1033. In addition, when the communication apparatus 1000 is a chip-type apparatus or circuit, the transceiver in the communication apparatus 1000 may alternatively be an input/output circuit and/or a communication interface, and may input data (or is referred to as receiving data) and output data (or is referred to as sending data). The processor is an integrated processor, a microprocessor, or an integrated circuit, and the processor may determine output data based on input data.

In a possible implementation, the communication apparatus 1000 may be used in a terminal device. Specifically, the communication apparatus 1000 may be a terminal device, or may be an apparatus that can support a terminal device in implementing functions of the terminal device in any one of the foregoing embodiments. The memory 1020 stores a computer program, a computer program or instructions, and/or data necessary for implementing functions of the terminal device in any one of the foregoing embodiments. The processor 1010 may execute the computer program stored in the memory 1020, to complete the method performed by the terminal device in any one of the foregoing embodiments.

In another possible implementation, the communication apparatus 1000 may be used in a network device. Specifically, the communication apparatus 1000 may be a terminal device, or may be an apparatus that can support a network device in implementing functions of the network device in any one of the foregoing embodiments. The memory 1020 stores a computer program, a computer program or instructions, and/or data necessary for implementing functions of the network device in any one of the foregoing embodiments. The processor 1010 may execute the computer program stored in the memory 1020, to complete the method performed by the network device in any one of the foregoing embodiments.

The communication apparatus 1000 provided in this embodiment may be used in a terminal device to complete the method performed by the terminal device, or may be used in a network device to complete the method performed by the network device. Therefore, for technical effects that can be achieved by the communication apparatus, refer to the foregoing method embodiments. Details are not described herein again.

In embodiments of this application, the processor may be a general-purpose processor, a digital signal processor, an application-specific integrated circuit, a field-programmable gate array or another programmable logic device, a discrete gate or transistor logic device, or a discrete hardware component, and may implement or execute the methods, steps, and logical block diagrams disclosed in embodiments of this application. The general-purpose processor may be a microprocessor, any conventional processor, or the like. The steps of the method disclosed with reference to embodiments of this application may be directly performed by a hardware processor, or may be performed by using a combination of hardware in the processor and a software module.

In embodiments of this application, the memory may be a non-volatile memory, for example, a hard disk drive (HDD) or a solid-state drive (SSD), or may be a volatile memory, for example, a random access memory (RAM). Alternatively, the memory may be any other medium that can be configured to carry or store expected program code in a form of instructions or a data structure and that can be accessed by a computer, but is not limited thereto. The memory in this embodiment of this application may alternatively be a circuit or any other apparatus that can implement a storage function, and is configured to store a computer program, a computer program or instructions, and/or data.

Based on the foregoing embodiments, refer to FIG. 11. Embodiments of this application further provide another communication apparatus 1100, including an input/output interface 1110 and a logic circuit 1120. The input/output interface 1110 is configured to receive code instructions and transmit the code instructions to the logic circuit 1120. The logic circuit 1120 is configured to run the code instructions to perform the method performed by the terminal device or the network device in any one of the foregoing embodiments.

The communication apparatus 1100 provided in this embodiment may be used in a terminal device or a network device, to perform the method performed by the terminal device or the network device, or may be used in a terminal device or a network device, to complete the method performed by the terminal device or the network device. Therefore, for technical effects that can be achieved by the communication apparatus, refer to the foregoing method embodiments. Details are not described herein again.

Based on the foregoing embodiments, an embodiment of this application further provides a communication system. The communication system includes at least one communication apparatus used in a terminal device and at least one communication apparatus used in a network device. For technical effects that can be achieved, refer to the foregoing method embodiments. Details are not described herein again.

Based on the foregoing embodiments, an embodiment of this application further provides a computer-readable storage medium. The computer-readable storage medium stores a computer program or instructions. When the instructions are executed, the method performed by the terminal device or the method performed by the network device in any one of the foregoing embodiments is implemented. The computer-readable storage medium may include any medium that can store program code, such as a USB flash drive, a removable hard disk drive, a read-only memory, a random access memory, a magnetic disk, or an optical disc.

To implement the functions of the communication apparatuses in FIG. 8 to FIG. 11, an embodiment of this application further provides a chip, including a processor, configured to support the communication apparatus in implementing the functions of the terminal device or the network device in the foregoing method embodiments. In a possible design, the chip is connected to a memory, or the chip includes a memory. The memory is configured to store a computer program or instructions and data that are necessary for the communication apparatus.

A person skilled in the art should understand that embodiments of this application may be provided as a method, a system, or a computer program product. Therefore, this application may use a form of a hardware-only embodiment, a software-only embodiment, or an embodiment with a combination of software and hardware. In addition, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to embodiments of this application. It should be understood that a computer program or instructions may be used to implement each procedure and/or each block in the flowcharts and/or the block diagrams and a combination of a procedure and/or a block in the flowcharts and/or the block diagrams. The computer program or instructions may be provided for a general-purpose computer, a dedicated computer, an embedded processor, or a processor of another programmable data processing device to generate a machine, so that the instructions executed by the computer or the processor of another programmable data processing device generate an apparatus for implementing a specified function in one or more procedures in the flowcharts and/or in one or more blocks in the block diagrams.

The computer program or the instructions may alternatively be stored in a computer-readable memory that can indicate the computer or another programmable data processing device to operate in a specific manner, so that the instructions stored in the computer-readable memory generate an artifact that includes an instruction apparatus. The instruction apparatus implements a specified function in one or more procedures in the flowcharts and/or in one or more blocks in the block diagrams.

The computer program or instructions may alternatively be loaded onto the computer or another programmable data processing device, so that a series of operation steps are performed on the computer or another programmable device to generate computer-implemented processing. Therefore, the instructions executed on the computer or another programmable device provide steps for implementing a specified function in one or more procedures in the flowcharts and/or in one or more blocks in the block diagrams.

It is clear that a person skilled in the art may make various modifications and variations to embodiments of this application without departing from the scope of embodiments of this application. In this case, this application is intended to cover these modifications and variations of embodiments of this application provided that these modifications and variations fall within the scope of the claims of this application and their equivalent technologies.

1. A resource scheduling method, comprising:
obtaining a computational power resource;
determining a computational power control parameter of one or more services; and
allocating the computational power resource to the one or more services based on the computational power control parameter.

2. The method according to claim 1, further comprising:
receiving configuration information from a network device, wherein the configuration information is used to determine the computational power control parameter.

3. The method according to claim 2, wherein the configuration information comprises a guaranteed time window and a first rate, the computational power control parameter is a product of the first rate and the guaranteed time window, the first rate is an amount of computational power allocated in unit time, and the guaranteed time window is used to determine duration of the computational power control parameter.

4. The method according to claim 1, wherein the computational power control parameter is a product of a second rate of the one or more services and first duration of the one or more services, wherein
the second rate is an amount of computational power allocated in unit time, and the first duration is duration between a moment at which the computational power control parameter is determined this time and a moment at which the computational power control parameter is determined last time.

5. The method according to claim 3, wherein when the product of the second rate and the first duration is greater than or equal to the product of the first rate and the guaranteed time window, the computational power control parameter is the product of the first rate and the guaranteed time window; or
when the product of the second rate and the first duration is less than the product of the first rate and the guaranteed time window, the computational power control parameter is the product of the second rate and the first duration.

6. The method according to claim 1, wherein allocating the computational power resource to the one or more services based on the computational power control parameter comprises:
allocating the computational power resource to the one or more services based on the computational power control parameter and a priority of the one or more services.

7. The method according to claim 6, wherein allocating the computational power resource to the one or more services based on the computational power control parameter comprises:
allocating a computational power resource to a service that has a highest priority and whose computational power control parameter is greater than 0 in the one or more services; or
allocating the computational power resource to the one or more services based on the computational power control parameter comprises:
allocating, when there is a service with an infinite rate in the one or more services, a computational power resource to the service with the infinite rate.

8. The method according to claim 6, further comprising:
discarding, when there is a remaining computational power resource, the remaining computational power resource; or
allocating, when there is a remaining computational power resource, the remaining computational power resource to a service whose computational power control parameter is greater than 0 in the one or more services.

9. The method according to claim 8, wherein discarding the remaining computational power resource comprises:
sending indication information of the remaining computational power resource to the network device, wherein the indication information of the remaining computational power resource indicates a request for deactivating the remaining computational power resource;
wherein allocating, when there is the remaining computational power resource, the remaining computational power resource to the service whose computational power control parameter is greater than 0 in the one or more services comprises:
allocating, when there is the remaining computational power resource, the remaining computational power resource in descending order of priorities of services whose computational power control parameters are greater than 0 in the one or more services.

10. The method according to claim 8, further comprising:
when there is the remaining computational power resource, and a size of a computational power resource requested by the one or more services is 0, allocating the remaining computational power resource to a service whose computational power control parameter is less than 0 in the one or more services.

11. The method according to claim 1, further comprising:
updating the computational power control parameter, wherein an updated computational power control parameter is determined based on the computational power control parameter and a computational power resource allocated to a corresponding service.

12. The method according to claim 1, further comprising:
receiving an association relationship between a service and a computational power resource, wherein the association relationship indicates that the computational power resource is used to execute the service, or the association relationship indicates that the computational power resource is not available for executing the service; and
allocating the computational power resource to the one or more services based on the computational power control parameter comprises:
allocating the computational power resource to the one or more services based on the association relationship and/or the computational power control parameter.

13. A resource scheduling method, comprising:
determining configuration information, wherein the configuration information is used by a terminal device to determine a computational power control parameter; and
sending the configuration information to the terminal device, wherein
the computational power control parameter is used by the terminal device to allocate a computational power resource.

14. The method according to claim 13, wherein the configuration information comprises a guaranteed time window and a rate, the computational power control parameter is a product of the rate and the guaranteed time window, the rate is an amount of computational power allocated in unit time, and the guaranteed time window is used to determine duration of the computational power control parameter.

15. The method according to claim 13, further comprising:
sending an association relationship between a service and a computational power resource to the terminal device, wherein the association relationship indicates that the computational power resource is used to execute the service, or the association relationship indicates that the computational power resource is not available for executing the service.

16. A communication apparatus, comprising a processor, the processor is configured to, when executing the programming instructions, enable the communication apparatus to:
obtain a computational power resource;
determine a computational power control parameter of one or more services; and
allocate the computational power resource to the one or more services based on the computational power control parameter.

17. The communication apparatus according to claim 16, the processor further enable the communication apparatus to:
receive configuration information from a network device, wherein the configuration information is used to determine the computational power control parameter.

18. The communication apparatus according to claim 17, wherein the configuration information comprises a guaranteed time window and a first rate, the computational power control parameter is a product of the first rate and the guaranteed time window, the first rate is an amount of computational power allocated in unit time, and the guaranteed time window is used to determine duration of the computational power control parameter.

19. The communication apparatus according to claim 16, wherein the computational power control parameter is a product of a second rate of the one or more services and first duration of the one or more services, wherein
the second rate is an amount of computational power allocated in unit time, and the first duration is duration between a moment at which the computational power control parameter is determined this time and a moment at which the computational power control parameter is determined last time.

20. The communication apparatus according to claim 18, wherein when the product of the second rate and the first duration is greater than or equal to the product of the first rate and the guaranteed time window, the computational power control parameter is the product of the first rate and the guaranteed time window; or
when the product of the second rate and the first duration is less than the product of the first rate and the guaranteed time window, the computational power control parameter is the product of the second rate and the first duration.
